(19) United States
(12) Patent Application Publication
(10) Pub. No.: US 2012/0070592 A1
(43) Pub. Date: Mar. 22, 2012

(54) Permeable Polymeric Films and Methods of Making Same

(76) Inventors: Alan D. Stall, Naperville, IL (US); Carl Frauenpreis, Wallingford, CT (US); Vladimir A. Sinani, Branford, CT (US); Tom L. Hicks, Port Jefferson, NY (US); Tatyana Y. Samoylova, Lowell, MA (US)

(21) Appl. No.: 13/322,276

(22) PCT Filed: May 26, 2010
(86) PCT No.: PCT/US10/36176

§ 371 Date: Nov. 23, 2011

Related U.S. Application Data
(60) Provisional application No. 61/180,964, filed on May 26, 2009.
(60) Provisional application No. 61/330,367, filed on May 2, 2010.

(51) Int. Cl. B32B 1/08; B29D 7/01; B32B 3/00

(52) U.S. Cl. 428/35.2; 428/220; 264/165

(57) ABSTRACT

A method of making a film and the resulting film are disclosed. A matrix polymer comprising at least 20 wt. % nylon-6 is combined with moisture-absorbing particles and mixed in an extensional flow mixer to disperse the moisture-absorbing particles in the matrix polymer. The mixed composition is formed into a film comprising at least 20 wt. % matrix polymer and 1 wt. % moisture-absorbing particles. The film is oriented in at least one direction by a ratio of at least 1.2:1 to provide an unperforated, oriented film having a thickness of at least 20 microns and a water transmission rate of at least 24 g/m2/hr. The film is useful in food casing applications.

This application claims the benefit of U.S. Provisional Patent Applications Ser. No. 61/180,964 filed May 26, 2009 and 61/330,367 filed May 2, 2010, each of which is incorporated herein in its entirety by reference.

The present disclosure relates generally to permeable polymeric films comprising moisture-absorbing particles and methods of making such films.

### BACKGROUND

Cellulose food casings are well known in the art and are widely used in the production of stuffed food products such as sausages and the like because they are highly permeable membranes, allowing high amounts of smoke and water transfer, which is a prerequisite for cooking most sausages. Cellulose food casings generally are tubes formed of a regenerated cellulose and contain a plasticizer such as water and/or a polyol such as glycerin. Tubular regenerated cellulose casing is typically extruded using a wet chemical regeneration process. Tube diameters are typically between 1 and 8 inches. Cellulose for making casings is most commonly produced by the so-called “viscose process.” In the viscose process, a natural high alpha content cellulose such as wood pulp or cotton linters is treated with a caustic solution to activate the cellulose to permit derivatization and extract certain alkali soluble fractions from the natural cellulose via mercerization. The resulting alkali cellulose is shredded, aged and treated with carbon disulfide to form cellulose xanthate. After aging to regulate the degree of polymerization, the cellulose xanthate is dissolved in a weak caustic solution creating viscose, which is a colloidal dispersion of 6-9% cellulose, 5-7% caustic, 1.5-2.5% CS₂ and water. The resulting solution or “viscose” is ripened, filtered, deaerated and extruded into coagulating and regenerating baths containing sodium and ammonium salts and sulfuric acid to produce a tube of regenerated cellulose, stripping off all the other chemicals in the viscose (as waste by-products) and producing pure cellulose as a finished product. The tube is subsequently washed, plasticized with glycerin or other polyol, and dried. The dry tube is then wound up as a flattened reel for further conversion (shirring, printing, etc).

### SUMMARY

One or more embodiments of the invention are directed to a method of making a film and the resulting film. A matrix polymer comprising at least 20 wt. % nylon-6 based on the weight of the matrix polymer is heated. Moisture-absorbing particles are added to the matrix polymer to form a combination of matrix polymer and moisture-absorbing particles. The combination of matrix polymer and moisture-absorbing particles is mixed in an extensional flow mixer to make a mixed composition having the moisture-absorbing particles dispersed in the matrix polymer. The mixed composition is formed into a film comprising at least 20 wt. % matrix polymer and 1 wt. % moisture-absorbing particles, based on the weight of the film. The film is oriented in at least one direction by a ratio of at least 1.2:1 to provide an unperforated, oriented film having a thickness of at least 20 microns and a water transmission rate of at least 24 g/m2/hr.

The features of various embodiments, and the manner of attaining them, will become more apparent and the embodiments will be better understood by reference to the following description of the disclosed embodiments taken in conjunction with the accompanying drawings.

### BRIEF DESCRIPTION OF THE DRAWINGS

FIG. 1 is a representative schematic diagram of embodiments of systems for producing films of the present invention.

FIG. 2 is a block diagram illustrating embodiments of methods of making the films in the system of FIG. 1.

FIG. 3 is a block diagram illustrating additional embodiments of methods of making the films in the system of FIG. 1.

FIG. 4 is a block diagram illustrating a method of testing water transmission rate.

FIG. 5 is a graph comparing films made according to the methods described herein to commercial films.

FIG. 6 is a representative schematic diagram of additional embodiments of systems for making the films.

FIG. 7 is a representative schematic diagram of additional embodiments of systems for making the films.

Corresponding reference characters indicate corresponding parts throughout the several views. Although the drawings represent embodiments of the present disclosure, the drawings are not necessarily to scale and certain features may be exaggerated to better illustrate and explain the embodiments. The exemplifications set out herein illustrate embodiments of the invention in several forms and such exemplification is not to be construed as limiting the scope of the invention in any manner.

### DETAILED DESCRIPTION

The embodiments discussed below are not intended to be exhaustive or limit the invention to the precise forms disclosed in the following detailed description. Rather, the embodiments are chosen and described so that others skilled in the art may utilize their teachings.

In various embodiments of the present invention, an unperforated film comprises matrix polymer and moisture-absorbing particles dispersed in the matrix polymer.

### Matrix Polymer

The matrix polymer may comprise at least, and/or at most, any of the following amounts of nylon-6, based on the weight of the matrix polymer: 20, 30, 40, 50, 60, 70, 80, 90, 95, 99, and 100 wt. %. Nylon-6 has a melting point of about 220° C. All references to melting point of a polymer, a resin, or a film layer in this application refer to the melting peak temperature of the dominant melting phase of the polymer, resin, or layer as determined by differential scanning calorimetry according to ASTM D-3418.

The matrix polymer may also comprise one or more additional polyamides, such as nylon-6/6,6, nylon-11, nylon-12, and nylon-6,I/6,T, in at least, and/or at most, any of the following amounts, based on the weight of the matrix polymer: 80, 70, 60, 50, 40, 30, 20, 10, 5, and 2 wt. %. The matrix polymer may be substantially free of material precluded by governmental agency for food use or food contact. For example, the matrix polymer may be substantially free of nylon-6/6,6, which in some applications and jurisdictions may have limited use as food contact material. For example, the United States 21 C.F.R. §177.1395 (“Laminate structures for use at temperatures between 120 ≧F and 250 ≧F”) provides limits of 212° C. exposure of nylon-6/6,6 only used in laminate layers, which for example, may be insufficient for high speed sausage manufacturing.

The matrix polymer may also comprise one or more additional thermoplastic polymers in addition to polyamide, such as polyvinyl alcohol (“PVOH”), polyurethane, and thermoplastic starch. The matrix polymer may be substantially free of thermoplastic polymer other than polyamide.

The film may comprise at least, and/or at most, any of the following amounts of matrix polymer, based on the weight of the film: 20, 30, 40, 50, 60, 70, 80, 90, 95, 99 wt. %.

### Moisture-Absorbing Particles

Moisture-absorbing particles are dispersed in the matrix resin of the film. “Moisture-absorbing” particles as used herein are particles that are capable of absorbing, or have absorbed, at least 10% of their original weight after immersion in pure water for 30 minutes at a temperature of 23° C. Useful moisture-absorbing particles include those that are approved, or could receive approval, for food contact by the relevant governmental agency. Examples include carbohydrate particles, polysaccharide particles, and non-hydrocarbon derivate particles.

Useful moisture-absorbing particles include cellulose particles. As used herein, “cellulose particles” includes materials comprising at least 50 wt. % cellulose based on the weight of the particle material, where “particle” includes configurations such as fibers and powders, such as finely chopped fibers. Exemplary cellulose particles include cotton fibers, fibers derived from high-purity alpha wood pulp, softwood and/or hardwood fibers (e.g., having fiber lengths of from 10 to 70 microns. Cellulose fiber particles are not considered significantly water-soluble, and may generally absorb up to 100% of their weight in water. Cellulose fiber begins to decompose at about 180° C., as evidenced by browning resulting from charring or scorching; and at about 220° C., the cellulose burns or decomposes extensively.

Other useful moisture-absorbing particles include starch particles and super absorbent polymer (“SAP”) particles (e.g., sodium polyacrylate SAP particles). Starch particles (e.g., corn starch particles) may have lower water absorption and swelling characteristics compared to cellulose particles. Starch particles may be available in relatively small particle sizes (e.g., 5 to 20 microns) useful for thin film or thin layer applications.

The film may comprise at least, and/or at most, any of the following amounts of moisture-absorbing particles, based on the weight of the film: 1, 3, 5, 8, 10, 15, 20, 25, 30, 35, 40, 45, 50, 55, 60, 65, 70, 75, and 80 wt. %. The moisture-absorbing material may comprise at least, and/or at most, any of the following amounts of cellulose particles, based on the weight of the moisture-absorbing particles: 50, 60, 70, 80, 90, 95, and 100 wt. %.

Embodiments of the films may include additives known in the art, such as processing aids, lubricants, antistatic additives, flow enhancers, stabilizers, pigments, and functional additives. For example, the film may include one or more of processing aid, lubricant, and/or mold release agents, for example, one or more of the stearate agents, such as calcium stearate, in an amount of at least any of at least, and/or at most 0.01, 0.1, 0.5, and 1 wt. %, based on the weight of the film. It is believe that such agents may at least partially coat the moisture-absorbing particles, and subsequently act as an agent on the surface of the moisture-absorbing particles to help create microvoids around the moisture-absorbing particles during the orientation of the film, as described herein.

### Water Transmission Rate

The oriented, unperforated film may have a thickness of at least 20 microns and a water transmission rate (WTR) of at least 24 g/m2/hr. The water transmission rate (WTR) test is described herein. The oriented, unperforated film may have a thickness of at least, and/or at most, any of the following: 20, 30, 40, 50, 80, 100, 150, and 200 microns. The oriented, unperforated film may have a WTR, for any of the previously recited film thicknesses, of at least, and/or at most, any of the following: 24, 28, 30, 35, 40, 50, 80, 100, 120, and 150 g/m2/hr.

### Making the Films

The following steps may be used in embodiments of methods of making the films of the present invention. The matrix polymer is heated, for example, by use of an extruder. The moisture-absorbing particles are added to the matrix polymer. This addition may occur before the matrix polymer is heated, during the heating of the matrix polymer, or after the matrix polymer has been heated. The combined matrix polymer and moisture-absorbing particles are mixed in an extensional flow mixer to make a mixed composition having the moisture-absorbing particles dispersed in the matrix polymer. The mixed composition is formed into a film, which is subsequently oriented.

### Heating the Matrix Polymer and Adding the Particles

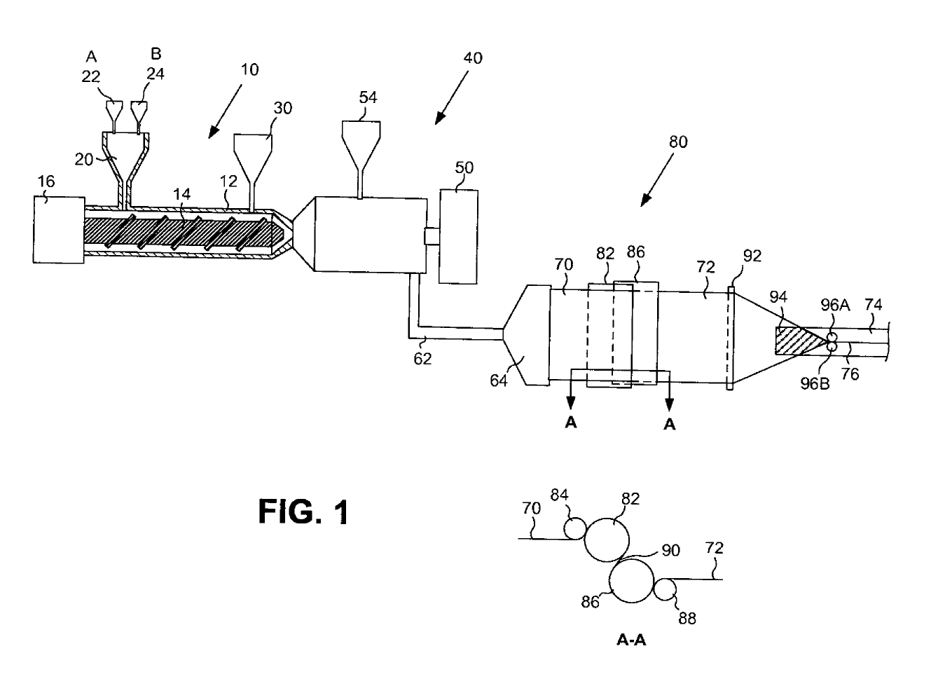

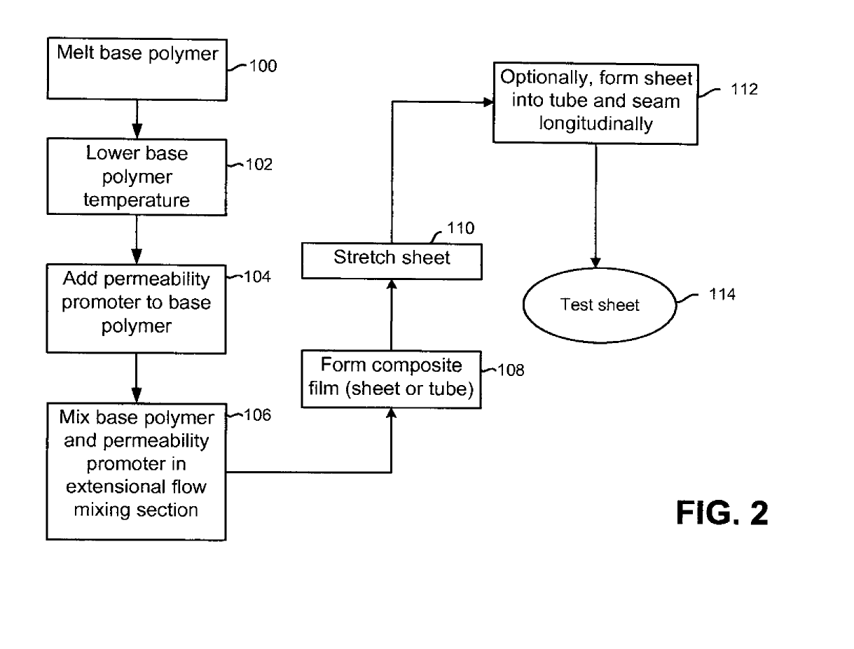

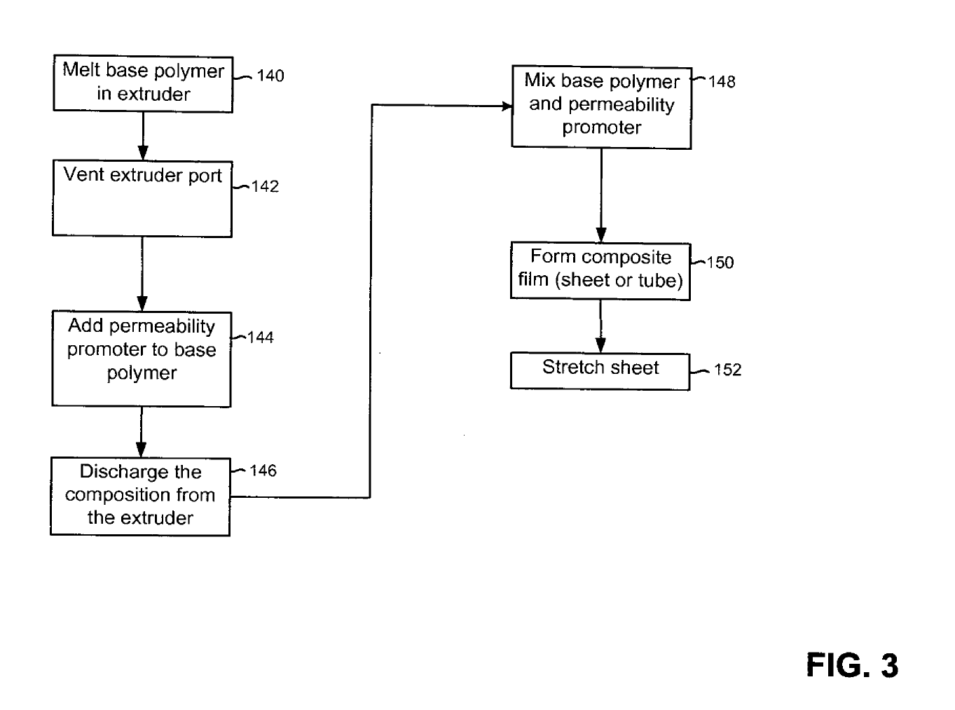

The matrix polymer may be heated by use of an extruder. (Step 100, FIG. 2, step 140, FIG. 3.) Extruder 10 comprises a barrel 12, a screw 14 supported within barrel 12, a hopper 20 for feeding feed materials through feeders 22 and 24 into barrel 12, and a motor 16 rotating screw 14. (FIGS. 1, 6, 7.) The feed materials include the matrix polymer and may include other additives described herein. As it rotates, screw 14 mixes and heats (or “melts”) the feed materials. An exemplary extruder of this type is the Thermo-Haake Polylab RC400P extruder with a Rheomex 252P Single Screw attachment. Although shown as a single-screw extruder, extruder 10 may comprise a twin-screw extruder. The extruder may have a plurality of sections and zones, such as a feed zone, melting zone, and metering zone (melt conveying zone). The extruder may be vented such that it is multi-staged (e.g., two-stage) with a decompression zone and metering zone. A section or zone may be ported, for example, to permit venting and/or provide a location or feeder 30 through which to add the moisture-absorbing particles. (FIG. 1.) The heating step may heat the matrix polymer to at least about, and/or at most about, any of the following: 198, 200, 205, 210, 215, 220, 235, and 240° C.

The moisture-absorbing particles may be added to the matrix polymer in one or more places along the melt stream depending on the time-temperature sensitivity of the moisture-absorbing particles. The insertion points may be selected based on the ratio of moisture-absorbing particles to matrix polymer, the characteristics of the materials, and the required capital investments to produce one arrangement compared to another.

The matrix polymer temperature may be lowered before the moisture-absorbing particles are added. (FIG. 2.) At step 100, the matrix polymer is heated in extruder 10 to form a “melt.” At step 102, the temperature of the molten matrix polymer may be lowered, for example, to help reduce the thermal degradation of the moisture-absorbing particles, for example, for cellulose particles, the temperature of the matrix polymer may be lowered to at most any of the following temperatures: 220° C., 210° C., 205° C., 200° C., and 195° C. At step 104, the moisture-absorbing particles are added to the matrix polymer, for example, near the end of the melting extruder, so that the following pressure building sections in that extruder, or a melt pump, may pressurize the composite melt to enter an extensional flow mixing section (discussed below), or else fed under pressure from a pressurized side feeder. The transfer may be accomplished “filter-free,” that is, without the use of a filter to screen suspended or agglomerated particles.

The addition of a mass of ambient temperature material such as the moisture-absorbing particles (having inherent heat capacity) may be used to “shock” cool the melt. The temperature of the melt may be lowered by venting the extruder to lower the extruder temperature zones. If the mixing section is coupled directly to the extruder screw, then moisture-absorbing particles may be fed through an extruder port provided before or in the extensional flow mixing section. If the mixing section operates independently from the extruder screw, then the moisture-absorbing particles may be fed through the inlet or through a feed port intermediate the inlet and outlet ports of the extensional flow mixer, allowing re-pressurizing.

The matrix polymer temperature may be lowered concurrently with the addition of the moisture-absorbing particles. (FIG. 3.) At step 140, the matrix polymer is heated in extruder 10 to form a “melt.” At step 142, the extruder is vented to lower the temperature of the matrix polymer. Venting the extruder lowers the barrel pressure allowing easier injection of materials. At step 144, the moisture-absorbing particles are added to the matrix polymer, for example, through an extruder port. This “side loading” step concurrently lowers the temperature of the matrix polymer to help reduce the exposure of the moisture-absorbing particles (for example, cellulose particles) to elevated temperatures that may otherwise degrade the particles, while allowing material such as the moisture-absorbing particles to be pumped into the extruder under pressure. Further, the addition of the moisture-absorbing particles provides a lower temperature mass that increases the cooling rate.

Thus, venting combined with the addition of the moisture-absorbing particles may be used to lower the matrix polymer temperature while minimizing the degradation of the moisture-absorbing particles if a sufficient mass of moisture-absorbing particles are added. Further, the moisture-absorbing particles may be added downstream from the extruder's melting zone to minimize the shear applied to the moisture-absorbing particles. Venting may also be used to lower the barrel pressure to reduce thermal degradation of the moisture-absorbing particles. The sections following the vent port are then pressurized to convey the composition out of the extruder and into mixer 40. (FIG. 1.) The moisture-absorbing particles may also be added after the extruder, for example at a juncture between the extruder and mixer 40 at the inlet port of mixer 40, or to mixer 40 through a feeder 54 which is disposed between its inlet and outlet ports of mixer 40 (described below). The moisture-absorbing particles can also be added in successive portions at various of the described locations.

### Mixing in an Extensional Flow Mixer

At step 146 (FIG. 3), the combination of matrix polymer and moisture-absorbing particles may be discharged (relatively poorly dispersed) from the extruder under pressure and fed to an extensional flow mixer. The combined matrix polymer and moisture-absorbing particles are mixed in an extensional flow mixer to make a mixed composition having the moisture-absorbing particles dispersed in the matrix polymer, for example, steps 106 and 148 of FIGS. 2 and 3, respectively.

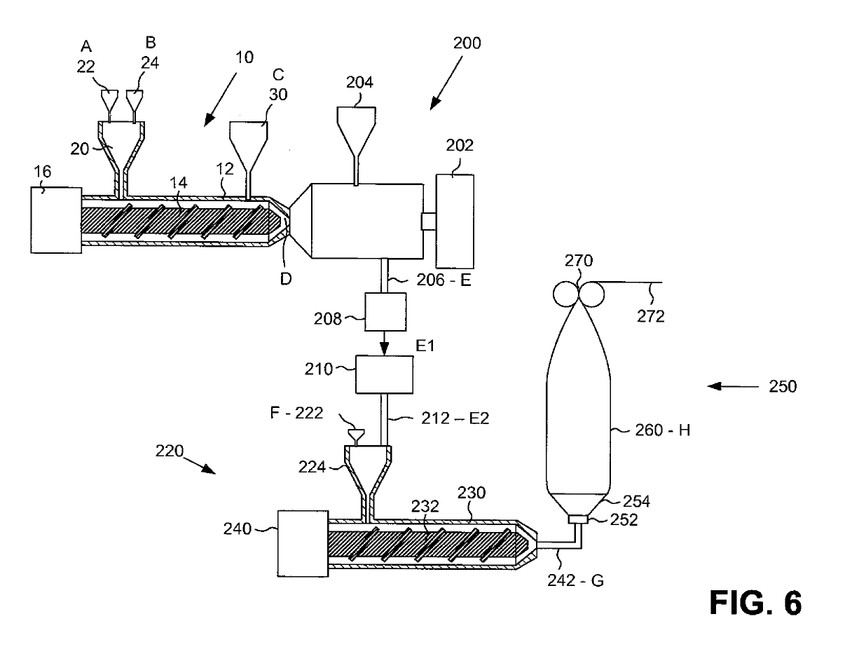

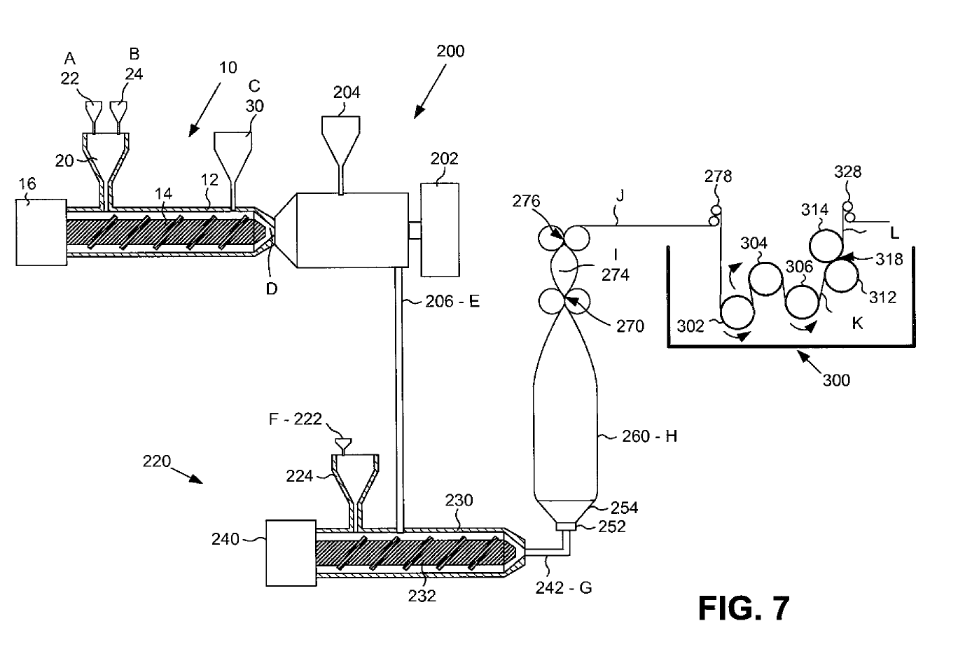

The extensional flow mixer may be provided as a section integral within the extruder barrel and proximate the outlet of the extruder, for example, by adding an extensional flow section to the extrusion screw. In addition or alternatively, the extensional flow mixer may be provided separate from the extruder, for example, outside of the extruder barrel. (FIGS. 1, 6, 7.) An extruder with the extensional flow mixing section incorporated within the extruder barrel may lack the ability to vary the speed of the mixing section independently from the extruder feeding and melting sections. However, the mixing section may be designed for the desired extrusion rotation speed, thereby reducing required capital expenditures. A separate extensional flow mixer allows a power source (e.g., drive system or motor 50, FIG. 1, drive system or motor 202, FIGS. 6-7) separate from that provided for the extruder, to provide different speed and torque control, may also provide additional process design flexibility (such as a low temperature zone). The extensional flow mixer may comprise a plurality of temperature controlled zones for selectively raising or lowering zone temperatures. During the mixing step in the extensional flow mixer the temperature may be controlled so that the temperature of (i) the mixed composition (resulting from the extensional flow mixing) and (ii) the combination of the matrix polymer and the moisture-absorbing particles (that are mixed in the extensional flow mixer) does not rise above, and/or does not fall below, any of 210° C., 205° C., 200° C., 198° C., and 195° C.

Mixer 40 comprises an extensional flow mixer (also known as an elongational flow mixer). (FIG. 1.) Exemplary extensional flow mixers for use in embodiments of the present method are disclosed in U.S. Pat. Nos. 5,451,106 and 6,550,956 to Utracki et al., U.S. Pat. No. 6,299,342 to Eggen et al., and U.S. Patent Application Publication 2009/0230223 published Sep. 17, 2009 (Ser. No. 12/399,010) to Stall et al. (the “Tek-Mix Application”), each of which is incorporated herein in its entirety by reference. Generally, the referenced extensional flow mixers have a housing providing a cavity or bore having an internal surface. A mandrel located in the cavity or bore carries protrusions (e.g., pockets) which vary according to each embodiment in number and characteristics. In some embodiments, the mandrel has few protrusions. In other embodiments, the mandrel has a multitude of protrusions. In one embodiment, protrusions are helical and have side surfaces which converge towards their outer edges, the outer edges cooperating with the internal surface of the cavity to divide the space between the protrusions and the internal surface into a series of chambers separated by slits such that the molten polymer composition passes successively through all the chambers and slits in moving from the inlet to the outlet, the side surfaces providing convergent entrances to, and divergent exits from, the slits, and the slits having cross-sectional areas which decrease in the liquid flow direction, from an upstream chamber adjacent the inlet, to the outlet. In another embodiment, the protrusions are concentrically arranged around a common axis and are conically tapered towards the outlet. In another embodiment, protrusions form barriers instead of chambers and the molten polymer composition flows over a multitude, but not all, of the barriers.

An exemplary extensional flow mixer has a first stage shear mixer (deagglomerator) and a second stage pocketed rotor/barrel section. The rotor and barrel have about 3,000 small pockets to cause repeated expansion and contraction of the melt to result in over 1,000 events at compressions of 3:1 to 5:1. The barrel has an average diameter of 50 mm. The rotor is tapered to have a 3:1 taper. The rotor has a 10:1 L/D ratio. The mixer uses up to 5 tons of water cooling and draws less than 10 HP at 20 to 50 lbs/hr typical throughput rates.

The extensional flow mixer may have a slit gap of any of at least, and/or at most, 0.25, 0.5, 1, 1.25, 1.5, and 2 mm. Slightly narrower gaps are permissible in zones of the mixer, for example in zones proximal to the outlet of the mixers.

Additional shear sections may be provided to enhance mixing efficiency, de-agglomerate large particles, and/or to raise the temperature of the molten matrix polymer or the mixed composition. Shear sections and manufacturers (e.g., Egan, UCC, Leroy, Dulmage, and Barr) are known to those of skill in the art of extrusion screw design. Shear sections adapted to be coupled to an extensional flow mixer are described in the Tek-Mix application.

The mixing in an extensional flow mixer may be accomplished “filter-free,” that is, without the use of a filter to screen suspended or agglomerated particles.

The mixed composition may be pelletized after leaving the extensional flow mixer (e.g., step 106, FIG. 2), in which case the mixed composition may be fed to a strand die for pelletizing, and subsequently re-melted before forming the mixed composition into a film.

### Forming the Mixed Composition into a Film

After mixing in the extensional flow mixer, the mixed composition is formed into a film. (Step 108 and step 150, FIGS. 2 and 3, respectively.) The mixed composition having the moisture-absorbing particles dispersed in the matrix polymer is discharged from the extensional flow mixer 40 to a melt pipe 62 and fed to a die. (FIG. 1.) Useful dies include blown film and cast film dies to which the mixed composition may be fed directly. An exemplary cast die 64 (FIG. 1) forms a sheet, or film, 70. A melt pump (not illustrated) may optionally be provided between mixer 40 and die 64 to enhance control of the formation of film 70, for example, by reducing the thickness variation and by generating additional pressure.

### Orienting the Film

After forming the mixed composition into a film, the film is oriented. (Step 110 and step 152, FIGS. 2 and 3, respectively.) The film is oriented by stretching (i.e., orienting) the film in at least one direction. Stretching may be performed in the machine direction, the transverse direction, or both (i.e., biaxially). Stretching techniques include continuous stretching, intermeshing-gear stretching, and biaxial stretching combining both continuous and intermeshing-gear stretching.

For example, film 70 is stretched to produce an oriented film 72 using machine direction orientation (MDO) stretcher 80. (FIG. 1.) Sectional view A-A illustrates MDO upstream and downstream stretching rolls 82 and 86, respectively, and also upstream and downstream nip rolls 84 and 88, respectively, which are not shown on the main view for clarity. The distance between the tangential points on stretching rolls 82 and 86 at which the film separates from roll 82 and contacts roll 86 comprise gap distance 90 which may be a fraction of an inch. Film 70 is stretched as it passes through the gap becoming film 72 when it contacts roll 86. Film 70 wraps around roll 82, and film 72 (stretched film) wraps around 86, sufficiently to prevent slippage. Nip rolls 84 and 88 are provided to isolate tension prior to and after MDO stretcher 80, and also to prevent film slippage on rolls 82 and 86. Rolls 82 and 86 are temperature controlled and of sufficient diameter to impart the desired temperature on film 70 before stretching and film 72 after stretching. Film 72 then passes over idler roll 92 and is wrapped around mandrel 94 where it is seamed by rollers 96A and 96B forming seam 76 and tube 74.

There are other methods for stretching a film. The film may be biaxially tentered in a tentering frame. The film may take the form of a tube that is extruded in a blown film process. If the permeability of the film is not so high as to create instability in a double bubble “captured air” process, then the tube may be stretched using conventional double-bubble equipment such as that shown in one or more of U.S. Pat. Nos. 3,278,663; 3,337,665; 3,456,044; 4,590,106; 4,760,116; 4,769,421; 4,797,235; and 4,886,634, each of which is incorporated herein in its entirety by reference. If stretching is difficult to achieve in a conventional double bubble process because the film's inherent high porosity causes difficulty in sustaining a stable secondary bubble, then transverse direction orientation may be achieved by tentering. Optionally, the tube may be laid flat and stretched in an MDO or intermeshing-gear stretcher without first slitting the tube into sheets.

The orientation of the film may take place in ambient air or heated air or by infrared heating (i.e., dry stretching), for example, in air having ambient or enhanced humidity. The orientation of the film may take place while submerged in, or otherwise exposed to, ambient or heated liquid water (i.e., wet stretching). For example, stretcher 80 may be submerged in water. (FIG. 1.) In such case, as the film stretches between rolls 82 and 86, the moisture-absorbing particles (e.g., cellulose particles) absorb water and swell. Water may subsequently be squeezed out of the stretched film and the film permitted to dry to reshrink the cellulose particles after swelling with water, which is believed to help create micropores or voids around the moisture-absorbing particles dispersed in the matrix polymer. Wet submerged stretching may increase the water transmission rate by at least 150% compared to stretching in air, even if the film is pre-wetted before stretching. By separating rolls 82 and 86 and/or, alternatively, adding additional rolls to increase the amount of stretching time (and swelling time), water transmission rate may be increased in excess of 200% compared to dry stretching.

The film may be oriented in at least one direction, for example, in either the machine (i.e., longitudinal) direction or the transverse direction, or in both directions (i.e., biaxially oriented). For example, the film may be oriented in one of the machine or transverse directions, or in both of these directions, by at least any of the following ratios: 1.2:1, 1.5:1, 1.8:1, 2:1, 2.5:1, 2.7:1, 3:1, 3.5:1, and 4:1. The film may be oriented in one of the machine or transverse directions, or in both of these directions, by no more than any of the following ratios: 10:1, 9:1, 8:1, 7:1, 6:1, 5:1, and 4:1. After orientation, the film may be heat set or annealed to reduce the heat shrink attribute to a desired level or to help obtain a desired crystalline state of the film.

It is believed that the stretching of the film enhances the water transmission rate (WTR) of the film by enhancing permeability paths between the moisture-absorbing particles sites where the moisture-absorbing particles are suspended. The amount of orientation to achieve the desired water transmission rate (WTR) characteristics of the oriented film may depend on the amount of moisture-absorbing particles dispersed in the matrix polymer, and the characteristics of the moisture-absorbing particles. Generally, the greater the amount of moisture-absorbing particles, then the lower the amount of stretching that is required to achieve the desired WTR and the stronger the film.

The film may optionally be formed into a tube and seamed longitudinally at step 112 (FIG. 2), for example, if the film was formed in a cast die. A non-tubular, flat film may also find utility in the applications described herein without being formed into a tube, especially since it lends readily to orientation in the machine direction (MD) and/or transverse direction (TD) without concerns of air leakage during orientation that may occur in a double bubble process. At step 114, a sample of the test film may be obtained and tested.

### Appearance Characteristics of the Film

The unperforated, oriented film may be transparent (at least in the non-printed regions) so that a packaged or enclosed article may be visible through the film. This may be advantageous, for example, where the film is used in meat casing applications, in order to view particle definition and color of the packaged meat. “Transparent” means that the film transmits incident light with negligible scattering and little absorption, enabling objects (e.g., the packaged article or print) to be seen clearly through the film under typical viewing conditions (i.e., the expected use conditions of the material).

The regular transmittance (i.e., clarity) of the unperforated, oriented film may be at least any of the following values: 65%, 70%, 75%, 80%, 85%, and 90%, measured in accordance with ASTM D1746. All references to “regular transmittance” values in this application are by this standard.

The total luminous transmittance (i.e., total transmittance) of the unperforated, oriented film may be at least any of the following values: 65%, 70%, 75%, 80%, 85%, and 90%, measured in accordance with ASTM D1003. All references to “total luminous transmittance” values in this application are by this standard.

### Additional Disclosure re Methods of Making the Film

Further embodiments of a method of making a the film are described with reference to material transformation steps A-H illustrated with reference to FIG. 6. In the method, cellulose particles (C) are added to a first matrix polymer (A) comprising relatively low viscosity polyamide, such as nylon-6 described herein, and at corresponding low temperature and, optionally, processing aids (B). The particles are added at a low enough temperature to prevent their volatilization. Without being bound by theory, it is believed that the relatively low viscosity matrix polymer coats the particles to help protects them from thermal degradation in subsequent method steps. The molten composition (D) is then mixed to form a mixed composition (E). The mixed composition (E) may be pelletized into pellets (E1) and subsequently dried into dried pellets (E2) before being let-down in a second matrix polymer (F) comprising a relatively high viscosity polyamide to form a second molten composition (G) which is formed into film (H). In an exemplary embodiment the first matrix polymer (A) comprises a relatively low-viscosity nylon-6 (e.g., Ultramid B27 available from BASF Corporation) and the second matrix polymer (F) comprises relatively high-viscosity nylon-6 (Ultramid B40 available from BASF Corporation). Let-down ratios may range from 30:70 to 80:20 depending on material selections. Due to a relatively low viscosity and cellulose content, it may be difficult to form a stable bubble with molten composition (D). The addition of the second matrix polymer (F) helps increase melt strength and helps to coat particles that may otherwise protrude to destabilize the primary bubble. Pre-coating the cellulose particles also reduces the thermal degradation expected if the cellulose particles are extruded with higher viscosity polymers alone (requiring correspondingly higher processing temperatures) alone. The composition (G) may also help avoid inclusion of (i.e., be substantially free from) additives that would preclude use of the resulting film (H) in food contact applications. For example, some viscosity-lowering additives may not be approved by relevant governmental agencies for food contact.

The methods described herein may be implemented in a blown film system 250 as shown in FIG. 6. The matrix polymer (A+B) is extruded in extruder 10, cellulose fibers (C) are added in hopper 30 (or 204 or both 30 and 204), and the molten composition (D) is mixed in mixer 204 comprising a drive system 202 and a melt pipe through which composition E is discharged. Mixer 200 is an extensional flow mixer as described herein to mix composition E by adding or creating little no heat, or providing enough cooling to operate near the freezing temperature of the composition. A pelletizer 208 and a dryer 210 are provided to produce dried pellets E2 which are conveyed through a melt pipe 212 into a feeder 224 of an extruder 220 having a drive system 240 driving a screw 232 within a barrel 230. The second matrix polymer F is fed through feeder 222 into barrel 230 where composition E2 and second matrix polymer F are melted and discharged through a melt pipe 242 as composition G and subsequently into a blown die 252 where composition G is blown into a bubble 260 comprising film H with the assistance of an air ring 254, preferably a dual-lip air ring. Film H passes through a nip 270 where bubble 260 is flattened into flat sheets of film 272. Subsequently film 272 may be stretched to increase its water transmission rate.

Further embodiments of a method of making a film will now be described with reference to material transformation steps A-L illustrated with reference to FIG. 7. A mixed composition (E) is formed as described above, fed into an extruder in the molten state, and subsequently let-down in a second matrix polymer (F) to form a second molten composition (G) which is formed into film (H) as described above. The first matrix polymer (A) may be a relatively low viscosity nylon-6 (e.g, Ultramid B27 and Ultramid B33) and the second matrix polymer (F) may be a relatively high viscosity nylon-6 (e.g., Ultramid B40). Let-down ratios may range from 30:70 to 80:20 depending on material selections. The unit operations (extruder 10, mixer 200, extruder 220, blown die 252) may avoid the use of a filter screen, although they may comprise breaker plates with orifices substantially larger than the maximum aspect of the cellulose particles. The film (J) is then wet-stretched to form a stretched film (K) in which cellulose particles have swelled. The stretched film (K) is then air-dried or squeeze-dried. If certain release characteristics are desired, the film in tubular state may be slugged or sprayed during shirring with release coatings containing various blends of alkyl-ketene dimmers, cellulose ethers, kymene (epichlorohydrin), paraffin waxes, glycerine, and polyethylene imine using equipment and technology shown, for example, as follows:

Slugging (salamis, bolognas, pepperonis) in U.S. Pat. Nos. 2,763,571; 2,901,358; 3,106,471; and 4,397,891 and WO/0075220 among others.

Spray shining (hot dogs, small sausages) in U.S. Pat. Nos. 4,137,947; 4,489,114; 5,782,683; 5,914,141; and 6,086,929, among others.

Slugging may be performed after the stretching step, and may be performed with the cast films described above after the films are sealed into tubular form. If non-water soluble coating are used in slugging (certain alkyl ketene dimers, for example, sold by Hercules Corporation under the Aquapels trade name), then slugging may be performed before stretching. Release agents giving controlled release are usually combinations of alkyl ketene dimers, kimene, epichlorohydrin, polyethylene imine, and cellulose ethers.

The methods described above may be implemented in the blown film system as shown in FIG. 7. A matrix polymer (A+B) is extruded in extruder 10, mixed with cellulose particles (C) in extensional flow mixer 200, let-down with a second matrix polymer (F), and then formed into film (H) in a film bubble 260. Peeling agent I is introduced into film (H) to form a second bubble 274. Coated film J passes through a water bath 300 between S-wraps 278 and 328 which provide tension isolation. In water bath 300, coated film J is stretched between rolls 302 and 304 and, optionally, between rolls 304 and 306. The stretching distances between rolls 302, 304 and 306 are sufficiently large to enable a desired amount of cellulose swelling which amount is determined in part by film thickness and the desired water transmission rate of the final product. More or less wrap may be provided around rolls 302, 304 and 306 to facilitate stretching by preventing film slip over the roll surfaces. Water (not shown) in water bath 300 may be held at a temperature about 90° Celsius and comprise sodium hypochlorite or other chemicals to maintain the water pH at about 8.5 eliminating bacterial activity. A pair of rolls 312 and 314 form a squeeze nip oriented so as to drain water away from the nip. Film L is thus formed which may be formed into a casing for food casing applications. The film may be slugged therein to coat the internal surface. A second nip 276 prevents peeling agent I to seep out of second bubble 274 except when adhered to nylon or cellulose.

### Water Transmission Rate Test

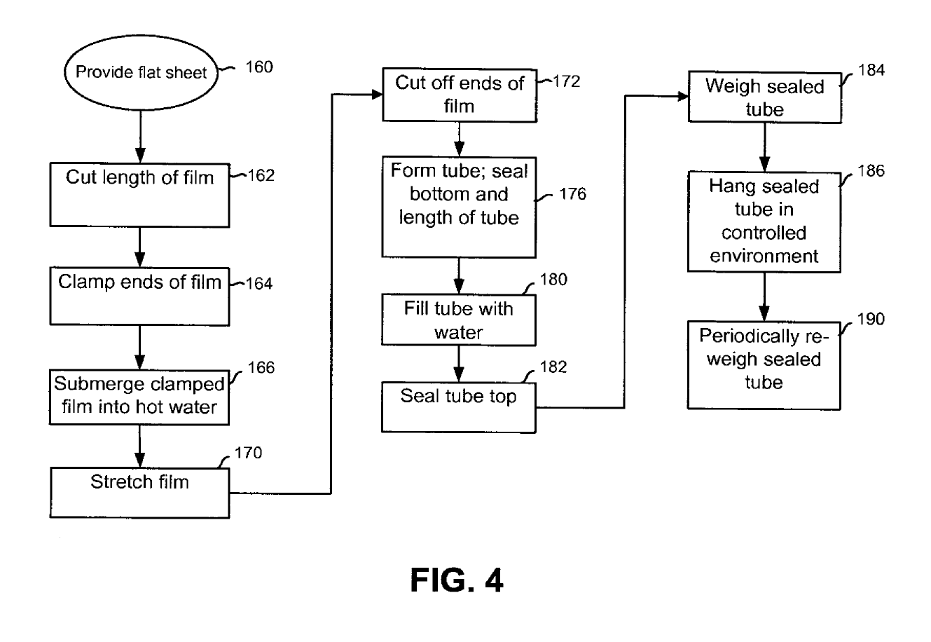

The water transmission rate (WTR) is determined by the test method as described herein. An unperforated, oriented representative sample of the film to be testing is obtained. If the film is not already in a tube configuration appropriate for testing, then the film is formed into a tube (step 176) by closing the film longitudinally by heat sealing or by (mechanically) clamping to form a longitudinal seam. The tube is closed transversely at one end (step 176) by heat sealing the end closed, clamping the end closed, or by tying the end tightly into a knot. (FIG. 4.) The heat sealing and/or clamping to form the seams use means sufficient to close or form the tube for the test without creating pinholes or leaks at the seam through which liquid water can escape.

The tube for testing is formed to have a diameter of from 1.5 cm to 3 cm. The length of the tube is sufficient to have a water-wetted length of 25 cm. The tube is filled with water (step 180) to have 25 cm height of wetted internal surface at 23° C. and the unsealed tube end is closed (step 182) as discussed above with respect to closing the other end. (FIG. 4.) The filled tube is then weighed (step 184) and is hung in a controlled environment (step 186) at 23° C. and 50% relative humidity. The tube is again weighed after eight hours (step 190). The film dimensions (length of wetted surface, diameter) and the tube diameter are determined to calculate the internal surface area of the tube. The weights of the sealed tube upon sealing, upon filling, and subsequently after eight hours are compared to calculate the water transmission rate.

The water transmission rate (WTR) is the weight of water loss (grams) after eight hours divided by the area of original wetted internal surface of the test tube (m2) and divided by the eight hour length of the test period:

WTR=(Weight of water loss, grams)/(Original wetted internal surface area, m2)/(8 hour test period)

The WTR is determined for an 8 hour period and reported in the dimensions of grams/m2/hour.

### Use of the Films

Embodiments of the films as disclosed herein may be used for meat packaging and cooking, for storage of moisture sensitive materials such as tobacco and vegetables, as dialysis membranes, popcorn bags, bread bags, air and water filtration films, battery separators, respiring cheese packaging, and diaper liners wherein water transmission is desirable to prevent heat rash. The films may be formed into tubes to serve as casings for sausage and other meat products and emulsions.

### EXAMPLES

The following examples are presented for the purpose of further illustrating and explaining one or more embodiments of the present invention and are not to be taken as limiting in any regard. Unless otherwise indicated, all parts and percentages are by weight.

In the examples below, these abbreviations have the following meanings

“PA6-40” is a nylon-6 (PA6 or “poly(caprolactam)”) available from BASF Corporation under the Ultramid B40 trade name and has a melting temperature of 220° C., a relative viscosity of about 4.0 (1% m/v in 96% m/m sulfuric acid (ISO 307 Huggins method)), and a viscosity number of about 250 (0.5% m/v in 96% m/m sulfuric acid (ISO 307), according to manufacturer's data.

“PA6-27” is a nylon-6 (PA6 or “poly(caprolactam)”) available from BASF Corporation under the Ultramid B27E-01 trade name and has a melting temperature of 220° C. and a relative viscosity of about 2.7 (1% m/v in 96% m/m sulfuric acid (ISO 307 Huggins method)), according to manufacturer's data.

Cellulose-1 is cellulose fiber available from CreaFill Fibers Company (Chestertown, Md.) under the CreaClear CC200LS trade name and having an average fiber length of 155 micron, an average fiber thickness of 1 to 2 micron, and a char point of 180° C., according to manufacture's data.

Films A1 to A4 and Films B1 to B4 were made as follows using a system and process similar to that shown and described above with respect to FIG. 1, except as noted below. First, Mixed Composition “A” was made by extruding the PA6-40 in an extruder (Coperion ZSK30 12 port) to soften the polymer and form a “melt.” Cellulose-1 was added to the extruder barrel to form a combination that moved through a high-shear zone provided downstream from the screw extrusion zones. The high-shear zone increased the mixing efficiency.

After the high-shear section, the melt moved next to an extensional flow mixer, which operated at a speed independent from that of the extruder. The extensional flow mixer dispersed the Cellulose-1 in the PA6-40 to form a mixed composition. The extensional flow mixer had a frustoconical-shaped modulating rotor having an inlet diameter smaller than its outlet diameter and 1,800 pockets on the rotor, with similar pockets on the barrel, to create modulating regions disposed on the rotor and barrel surfaces. The resulting Mixed Composition A was pelletized, and had 20 wt. % Cellulose-1 and 80 wt. % PA6-40.

Mixed Composition “B” was made in the same manner as Mixed composition “A,” except that Mixed Composition B had 30 wt. % Cellulose-1 and 70 wt. % PA6-40. Table 1 summarizes the mix compositions.

TABLE 1

| | Mix “A” | Mix “B” |
|---|---|---|
| PA6-40, | 80 | 70 |
| weight % | | |
| Cellulose-1, | 20 | 30 |
| weight % | | |

Each of the pelletized Mixed Compositions A and B were fed to an screw extruder to melt the pellets and extrude the melt through a cast die to form pre-stretched films A and B. Each of the pre-stretched films A and B were stretched in the machine direction only under the different conditions and amounts shown in Table 3 to produce Films A1-A4 and Films B1-B4 from the Mixed Compositions A and B. The films were stretched submerged in water at 90° C. uniaxially from a 3.5 inch strip to 10.5 inches (i.e., a 3:1 stretch ratio).

Comparative Film C1 was a film of 100% PA6-40, which was extruded on the same equipment as the Films A and B. The C1 Film was 147 microns thick, and was uniaxially oriented from 3.75 inches to 10.5 inches (i.e., a 2.8:1 stretch ratio) and then heat sealed into a tube having a 1.5 cm diameter and a wetted length of 15.5 cm. Comparative Film C2 was a pure regenerated cellulose casing available from Globe Casing Co. (New York, N.Y.) under the Viscofan trade name. The Film C2 was obtained as a tube having a 2.5 cm diameter, a 32 micron “dry” thickness and a 22 cm wetted length. The ends were closed by tying tightly into knots to form the closed ends.

Each of the Films A1 to A4 and Films B1 to B4 were made into tubes having the diameters and other characteristics as shown in Table 2. The water transmission rate (WTR) for each of the Films Al through B4 and the Comparatives was measured according to the description of the WTR test provided herein. Table 2 shows information in columns 2-6 used to calculate the WTRs shown in column 7. The ratio of the various WTRs of the Films to the WTR of Comparative Film C2 is shown in column 8.

TABLE 2

| | | | | COL 5 | COL 6 | COL 7 | COL 8 |
|---|---|---|---|---|---|---|---|
| | | | COL 4 | Initial | Final | Water | Ratio: WTR of |
| COL 1 | COL 2 | COL 3 | Tube | Tube plus | Tube plus | Transmission | Samples |
| Tube | Diam. | Thick. | Weight | Water | Water | Rate | to WTR |
| Sample | (cm) | (mm) | (gr) | Weight (gr) | Weight (gr) | (gr/m²/hr) | of C2 (%) |
| A1 | 2.0 | 0.062 | 1.34 | 39.27 | 37.19 | 24.4 | 18.4 |
| A2 | 2.0 | 0.091 | 1.79 | 34.15 | 31.16 | 42.5 | 32.0 |
| A3 | 2.0 | 0.098 | 1.94 | 39.94 | 36.68 | 46.3 | 34.8 |
| A4 | 2.0 | 0.083 | 2.04 | 54.83 | 52.27 | 31.8 | 24.0 |
| B1 | 2.0 | 0.116 | 2.48 | 55.01 | 51.53 | 43.3 | 32.6 |
| B2 | 1.5 | 0.147 | 2.54 | 24.23 | 20.81 | 64.7 | 48.7 |
| B3 | 1.5 | 0.136 | 2.00 | 28.43 | 25.95 | 47.0 | 35.4 |
| B4 | 2.0 | 0.109 | 1.41 | 19.71 | 17.89 | 36.3 | 27.4 |
| C1 | 1.5 | 0.147 | 3.20 | 28.22 | 27.97 | 3.8 | 2.9 |
| C2 | 2.5 | 0.032 | 1.55 | 53.57 | 40.45 | 132.9 | 100.0 |

TABLE 3

| | Stretching Conditions | | | Ratio: WTR of |
|---|---|---|---|---|
| | | Temperature | | Samples to |
| Sample | % | ° C. | Cellulose | WTR of C2, % |
| A1 | 125 | 90 | 20% | 18.4 |
| A2 | 200 | 90 | | 32.0 |
| A3 | 200 | 89 | | 34.8 |
| A4 | 200 | 89 | | 24.0 |
| B1 | 163 | 85 | 30% | 32.6 |
| B2 | 140 | 90 | | 48.7 |
| B3 | 200 | 88 | | 35.4 |
| B4 | 200 | 88 | | 27.4 |
| C1 | 180 | 85 | 0% | 2.9 |
| C2 | 0 | NA | 100% | 100.0 |

### Stretch Burst Test

As described above, the films of the present invention may be formed into casings for use in packaging foodstuffs such as meat. In such applications, pressurized foodstuffs are inserted, or stuffed, into the casing which expands as a result. The casing must withstand the stuffing pressure and should also have residual strength and elasticity to withstand additional pressure which may be encountered during further packaging, transportation, and the like. A typical test performed to characterize the casing's stretching capability is referred to as the “Stretch-Burst” test and is detailed in U.S. Statutory Invention Registration No. H1592 and U.S. Pat. No. 5,470,519, each of which is incorporated herein in its entirety by reference. Typical casing stuffing pressures range are about 150 mm Hg in hot dog casings (diameters 13 mm to 40 mm) and are 200 to 250 mm Hg in fibrous casings (reinforced casings typically greater than 36 mm diameter up to 200 mm diameter). A casings comprising the films of the present invention may have a stretch-burst internal pressure at burst of at least 250 mm Hg (e.g., for hot dog use). About 50 mm Hg of pressure is generally used to inflate and de-wrinkle the casing. After inflation, a casings comprising the films of the present invention may withstand diametral expansion up to 10% caused by a rise in internal stuffing pressure during cooking from 50 mm Hg to 150 mm. This expansion provides a “shock absorber” effect when the pressurized cold meat emulsion is pumped initially into the casing.

In the Stretch-Burst Test, a sample of tubular casing is soaked in room temperature water for at least about 30 minutes to simulate conditions of use, for example, in sausage processing operations where casings are exposed to moisture and water in a variety of steps. Additionally soaking allows glycerine in regenerated cellulose to leach out and full imbibition of water so the final effect measured is of pure cellulose alone. The dry flat width and rewet flat width (after soaking) of the casing may be measured and recorded. One end of the casing is clamped shut and the other end is secured about an air nozzle. The casing is slowly inflated with air from the nozzle. The diameter of the casing is measured at various pressures as the air pressure inside the inflated casing is continuously increased until the casing ruptures (bursts). The pressure and diameter at the bursting point is noted. Sufficient samples may be similarly tested to obtain a representative average. The sample may be, for example, approximately 18 inch in length but may be longer or shorter depending upon the selected measurement apparatus.

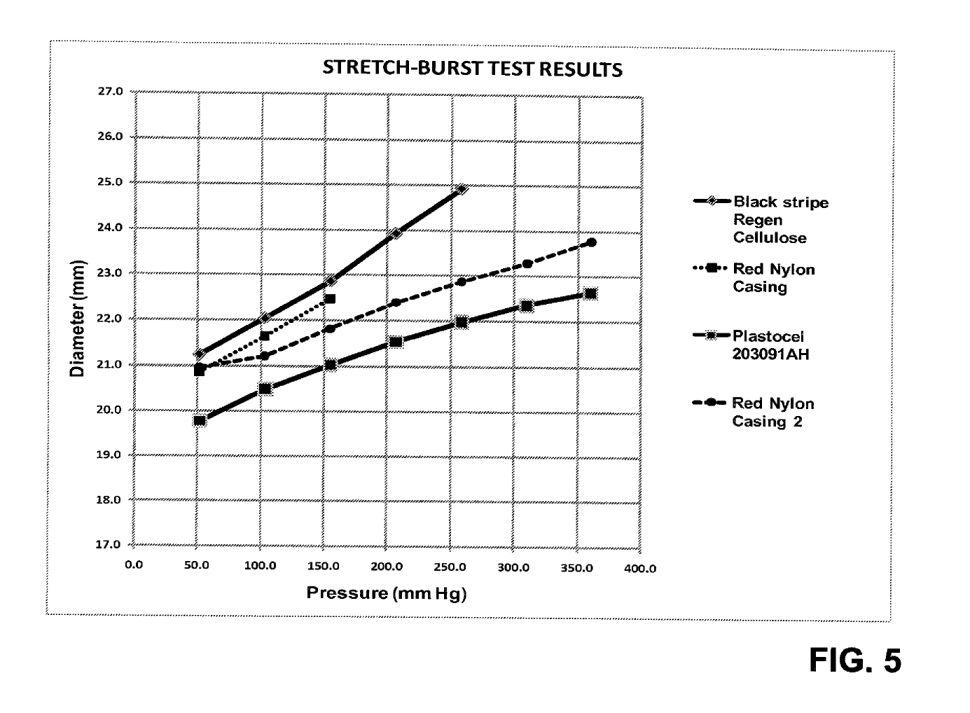

Referring to FIG. 5, test results are shown comparing a casing made according to the method described herein, Plastocel 203091AH, to black stripe regenerated cellulose, red nylon casing, a second red nylon casing, which are commercially available casings. The Red casing is supplied by Atlantis-Pak Company (Russia) and is believed to be a monolayer nylon-6 casing using equipment from Kuhne Corporation (Germany). The casing was 24 microns thick, 24 mm in diameter, equivalent to a U.S. calibre 27. It can be seen in FIG. 5 that the slope of each of the four curves is similar. The slope may be estimated roughly by dividing the difference between the stuffing and minimum diameters for each sample by the difference between the stuffing and minimum inflation pressures.

The result indicates the amount of expansion the casing will withstand per unit of pressure. The slopes of the lines calculated according to this method are 0.0163, 0.0161, 0.0124 and 0.0087 mm/mm HG for regenerated cellulose, nylon casing, Plastocel 203091AH, and a second sample of red nylon casing, respectively, noting that the first sample of red nylon casing burst at 155.1 mm Hg. The stuffing elasticity of the four samples, calculated as the ratio of diameters at 50 Hg and 150 mm Hg, are 107.7%, 107.7%, 106.3 and 104.1% for regenerated cellulose, nylon casing, Plastocel 203091AH, and a second sample of red nylon casing, respectively. The Plastocel sample shows stuffing elasticity equivalent to commercially available casings without transverse-direction orientation which is required to produce the other samples. This is an example of cellulose filler stiffening a nylon-cellulose composite.

### Example 9

A pelletized mixed composition was formed in the manner described above with respect to Mixed Compositions A and B except as noted below.

Cellulose-1 was dried at 80° C. for 48 hours. Calcium stearate, HTP Ultra-fine talc, and calcium carbonate were blended with the dried Cellulose-1 to form a pre-blend. PA6-27 was dried at 80° C. for 8 hours at −40° C. dew point. The pre-blend was combined with the dried PA6-27 using a Single-Screw Sterling 2-inch single-screw extruder. The compounding rate was 7 kg/hr, 50 rpm screw speed (Xaloy Nanomixer screw), temp 220° C. The single-screw extruder was coupled to an extensional flow mixer (Tek-Mix mixer), which used an EFM Stage 1 Extensional Flow mixer and a tapered pocketed stage 2 rotor/barrel. The RPM was 70, gap was 2.5 mm, and temperatures were 175° C., 170° C., 170° C. in the mixer. The Tek-Mix mixer discharge melt temperature was 225° C. The final melt exited through a conventional 1 hole die to produce strands, which were then chopped into pellets. The composition of the pellets was:

| | |
|---|---|
| PA6-27 | 94.522% |
| Cellulose-1 | 5.00% |
| Calcium Stearate | 0.144% |
| Talc | 0.190% |
| Calcium Carbonate | 0.144% |
| Total | 100% |

The mixed composition pellets from above were dried at 80° C. for 8 hours. PA6-40 was dried at 80° C. for 8 hours. The dried PA6-40 and the mixed-composition pellets were blended together at a 60/40 weight ratio so that the resulting blended material had a calculated composition of:

| | |
|---|---|
| PA6-40 | 40% |
| PA6-27 | 56.7132% |
| Cellulose-1 | 3.00% |
| Calcium Stearate | 0.0864% |
| Talc | 0.114% |
| Calcium Carbonate | 0.0864% |
| Total | 100% |

The blend was fed into the throat of a Davis Standard 1″ single-screw extruder, 24:1 L/D, 5 HP. The extruder fed a modified side-feed blown film die, ⅝ inch diameter, 0.030 inch gap, process rate 2.6 kg/hr, 49 extruder RPM, average extruder temperature 450° F. (232° C.), with exit melt temperature 491° F. (255° C.).

A film was extruded at a line speed 13 ft/min to have a thickness of 76 microns and a tubular diameter of 2.3 inches. At this point the film was not stretched in either the machine or transverse directions. The film was then blown using a blow up ratio of approximately 3.6:1 and a draw ratio of 1:1. The resulting blown, tubular film was wound as a flattened reel.

The blown tubular film was subsequently oriented in the machine-direction (“MD” stretched) as a flattened tubular film submerged in a 80° C. hot water bath, at 97% stretch, using a sample of 9¼ inches stretched to 18¼ inches. There was no transverse direction (“TD”) stretch.

The resulting Example 9 oriented tubular film tube was cut and then heat sealed into a 2.3 cm diameter tube, and filled with room temperature water to a wet length of 19 cm. The tube was sealed on the top and bottom, and was hung in an ambient temperature environment for 8 hours in order to measure the weight loss to calculate the WTR. The WTR was 116.5 g/m²/hr. Comparative Film C2 (Viscofan regenerated cellulose) of similar dimensions had a WTR of 133 g/m²/hr. Thus, the Example 9 film had a good WTR for use as a casing, that is, a WTR of 88% of the WTR of a comparative commercial regenerated cellulose casing.

The Example 9 casing had a elastic recovery such that in inflating the tube from 1 psi to 4 psi and returning it to normal pressure, the diameter of the tube went from 21 mm to 24 mm, and returned to about the same initial diameter basically along the same path line as it had expanded. The Example 9 casing thus had good elastic recovery for expected use conditions in a meat processing application.

The Example 9 casing was tested with Terra-Sorb gel (potassium hydrate) at room temperature to measure elongational distortion and stability. A low number is good, indicating the casing will not elongate into a torpedo shape. The casing elongated 2.0% under up to 3 psi pressure, which is the maximum the casing is expected to be exposed to during cooking.

Any numerical value ranges recited herein include all values from the lower value to the upper value in increments of one unit provided that there is a separation of at least 2 units between any lower value and any higher value. As an example, if it is stated that the amount of a component or a value of a process variable (e.g., temperature, pressure, time) may range from any of 1 to 90, 20 to 80, or 30 to 70, or be any of at least 1, 20, or 30 and/or at most 90, 80, or 70, then it is intended that values such as 15 to 85, 22 to 68, 43 to 51, and 30 to 32, as well as at least 15, at least 22, and at most 32, are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The above descriptions describe various embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference. All references to ASTM tests are to the most recent, currently approved, and published version of the ASTM test identified, as of the priority filing date of this application. Each such published ASTM test method is incorporated herein in its entirety by this reference.

1. A method of making a film comprising:
heating matrix polymer comprising at least 50 wt. % nylon-6 based on the weight of the matrix polymer;
adding moisture-absorbing particles to the matrix polymer to form a combination of matrix polymer and moisture-absorbing particles;
mixing the combination of matrix polymer and moisture-absorbing particles in an extensional flow mixer to make a mixed composition having the moisture-absorbing particles dispersed in the matrix polymer;
forming the mixed composition into a film comprising at least 20 wt. % matrix polymer and 1 wt. % moisture-absorbing particles, based on the weight of the film; and
orienting the film in at least one direction by a ratio of at least 1.2:1 to provide an unperforated, oriented film having a thickness of at least 20 microns and a water transmission rate of at least 24 g/m2/hr.

2. The method of claim 1 wherein the unperforated, oriented film has a water transmission rate of at least 28 g/m2/hr.

3. The method of claim 1 wherein the matrix polymer comprises at least 60 wt. % nylon-6 based on the weight of the matrix polymer.

4. The method of claim 1 wherein the oriented, unperforated film has a thickness of at least 30 microns.

5. The method of claim 1 wherein the film comprises matrix polymer in an amount of at least 30 wt. % based on the weight of the film.

6. The method of claim 1 wherein the film comprises moisture-absorbing particles in an amount of at least 3 wt. % based on the weight of the film

7. The method of claim 1 wherein the moisture-absorbing particles comprise cellulose particles in an amount of at least 50 wt. % based on the weight of the moisture-absorbing particles.

8. The method of claim 1 wherein the heating step heats the matrix polymer to at least 200° C.

9. The method of claim 1 wherein the orientation step orients the film in at least one direction by a ratio of at least 1.5:1.

10. The method of claim 1 wherein the matrix polymer comprises relatively low-viscosity nylon-6 and relatively high-viscosity nylon-6 and the relatively high-viscosity nylon-6 is added to the mixed composition subsequent to the mixing step using the extensional flow mixer.

11. The method of claim 1 wherein during the mixing step in the extensional flow mixer, the temperature of (i) the mixed composition and (ii) the combination of the matrix polymer and the moisture-absorbing particles does not rise above 210° C.

12. The method of claim 1 wherein the unperforated, oriented film has a regular transmittance of at least 65%.

13. A film formed by the method of claim 1.

14. A film comprising:
at least 20 wt. % matrix polymer based on the weight of the film, the matrix polymer comprising at least 50 wt. % nylon-6 based on the weight of the matrix polymer; and
at least 1 wt. % moisture-absorbing particles based on the weight of the film; wherein:
the film is unperforated and has a thickness of at least 20 microns; and
the moisture-absorbing particles are dispersed in the matrix polymer to provide a water transmission rate of at least 24 gr/m2/hr.

15. The film of claim 14 wherein the film has a water transmission rate at least 28 g/m2/hr.

16. The film of claim 14 wherein the matrix polymer comprises at least 60 wt. % nylon-6 based on the weight of the matrix polymer and the film comprises at least 30 wt. % matrix polymer based on the weight of the film.

17. The film of claim 14 wherein the film has a thickness of at least 30 microns.

18. (canceled)

19. The film of claim 14 wherein the film comprises moisture-absorbing particles in an amount of at least 3 wt. % based on the weight of the film

20. The film of claim 14 wherein the moisture-absorbing particles comprise cellulose particles in an amount of at least 50 wt. % based on the weight of the moisture-absorbing particles.

21. (canceled)

22. A casing tube comprising the film of claim 14.
